(19) United States
(12) Patent Application Publication
(10) Pub. No.: US 2006/0290526 A1
(43) Pub. Date: Dec. 28, 2006

(54) Programmable wearable no-power display

(75) Inventor: Charles T. Golson, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/165,924

(22) Filed: Jun. 24, 2005

(51) Int. Cl. G08B 21/00

(52) U.S. Cl. 340/641

(57) ABSTRACT

A tag is provided for attachment to a garment. The tag includes a housing, image retaining material disposed within the housing, the image retaining material capable of displaying a first static image in the absence of an electric field and transforming the first static image to a second static image in the presence of an electric field, and a fastener coupled to the housing and configured to attach the housing to the garment.

### FIELD OF THE INVENTION

The present invention generally relates to no-power displays, and more particularly relates to the use of no-power displays.

### BACKGROUND OF THE INVENTION

Tags are used in myriad applications to communicate identifying information to a reader. For example, some tags are used to identify a person. These tags can have any one of a number of configurations. In many cases, the tags are made of an inexpensive sheet of material onto which the identifying information is handwritten. The sheet may be sized to a desired dimension and inserted into a protective sleeve having a clip attached thereto. Alternatively, the sheet may include an adhesive coating thereon that allows the tag to be attached to a surface, such as to clothing.

Although these tags are useful, they do suffer certain drawbacks. For example, the tags are not reusable and are typically discarded after a single use. Additionally, if the identifying information written on the tag is incorrect, the incorrect information may need to be crossed out, which may cause confusion for the reader. Moreover, although the tags are relatively inexpensive, tags are typically discarded after single use and as a result, new tags are purchased on a continuous basis. Thus, long-term costs associated with procuring the tags may be relatively high.

Accordingly, it is desirable to have a system that provides a tag that is reusable. It is also desirable for the system and the system components to be relatively inexpensive. In addition, it is desirable to have a tag that is lightweight and appropriately sized to be wearable. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In one exemplary embodiment, a tag is provided for attachment to a garment. The tag includes a housing, image retaining material and a fastener. The image retaining material is disposed within the housing and is capable of displaying a first static image in the absence of an electric field and transforming the first static image to a second static image in the presence of an electric field. The fastener is coupled to the housing and configured to attach the housing to the garment.

In another exemplary embodiment, a tag is provided for attachment to a garment that includes a wearable housing, a display plate, a cell, image retaining material, and a fastener. The wearable housing has an opening formed therein. The display plate is disposed over at least a portion of the opening. The cell is disposed within the housing that cooperates with the image retaining material to form at least one of a focal conic, planar, and homeotropic alignment configuration that are stable in the absence of an electric field. The image retaining material is disposed within the cell and visible through the display plate and comprises a plurality of crystals capable of forming a stable at least one of the focal conic, planar, and homeotropic alignment configurations in the absence of an electric field. The fastener is coupled to the housing and configured to attach the housing to the garment.

In still another exemplary embodiment, a wearable display system is provided that includes a wearable housing, a display plate, a cell wall structure, image retaining material, an electrode, drive circuitry, and an electrical interface. The wearable housing has an opening formed therein. The display plate is disposed over at least a portion of the housing opening. The cell wall structure is disposed in the housing and includes at least one cell. The image retaining material is disposed within the cell and visible through the display plate, and comprises a plurality of crystals capable of forming stable focal conic, planar, and homeotropic alignment configurations in the absence of an electric field. The electrode surrounds at least a portion of the image retaining material. The drive circuitry is electrically coupled to the electrode for applying selected voltages to the electrode for transforming at least a portion of the image retaining material to at least one of the focal conic, planar, and homeotropic alignment configurations. The electrical interface is coupled to the housing and electrically coupled to the drive circuitry.

### BRIEF DESCRIPTION OF THE DRAWINGS

The present invention will hereinafter be described in conjunction with the following drawing figures, wherein like numerals denote like elements, and

FIG. 1 is a schematic of an exemplary display system;

FIG. 2 is a cutaway view of an exemplary wearable tag that may be implemented in the display system depicted in FIG. 1; and

FIG. 3 is a perspective view of the exemplary display system integrated into a hat.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

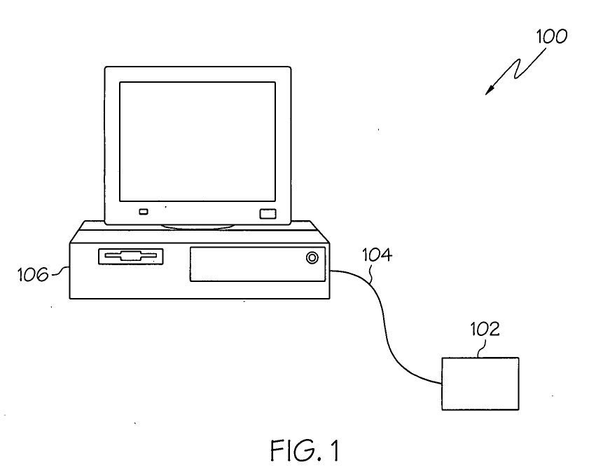

Turning now to the description, FIG. 1 shows an exemplary display system 100 that includes a wearable tag 102, a cable 104, and a computer 106. The tag 102 is configured to display an image, alphanumeric text, or any other textual or graphical representation without an external power source. Preferably, a static image is displayed.

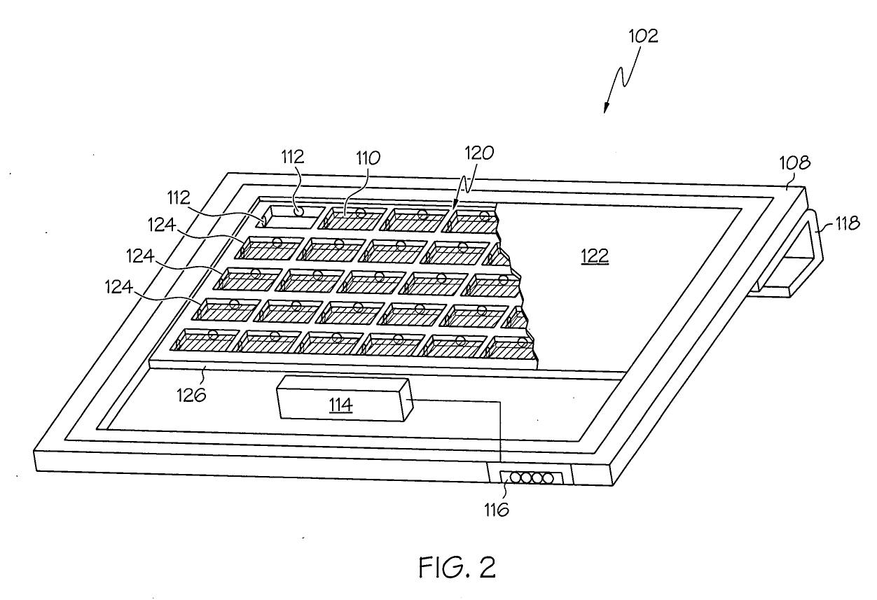

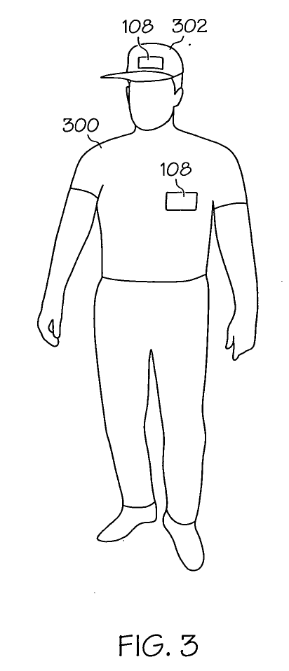

FIG. 2 is a cutaway view of an exemplary tag 102 that may be used as part of the display system 100. The tag 102 includes a housing 108, an image retaining material 110, electrodes 112, drive circuitry 114, and an electrical interface 116. The housing 108 may be constructed of any lightweight material and is preferably configured to be attachable to a garment. In this regard, the housing 108 may be relatively small, such as, for example, the size of a business card, and preferably includes a fastener 118 integrally formed therein or mounted thereto. The fastener 118 may be any one of numerous suitable coupling devices, such as a pin, a clip, or a hook and loop fastening system. Alternatively, the fastener 118 may be a system that includes a loop formed on or coupled to the housing 108 and a wire or thread that is inserted through the loop. In such an embodiment, the housing 108 may be integrated into the garment, which may be, for example, an article of clothing 300 or a hat 302, as shown in FIG. 3. Turning back to FIG. 2, the housing 108 also includes a display opening 120 formed therein that has a display plate 122 disposed thereover.

The image retaining material 110 is disposed within the housing 108. The image retaining material 110 preferably comprises crystals that are capable, upon the application of an electric field, of being positioned in various alignment configurations, such as in a planar, focal conic, or homeotropic configuration. Additionally, the image retaining material 110 is capable of remaining in the alignment configuration in the absence of an electric field or any other source of power. It will be appreciated that the various alignment configurations allow light to either pass through the crystals or reflect off of the crystals to thereby form an image that is visible to a viewer via the display plate 122. Thus, the image retaining material is capable of displaying a first static image in the absence of an electric field and transforming the first static image to a second static image in the presence of an electric field. Suitable materials include, but are not limited to bistable cholesteric liquid crystal display materials and chiral nematic liquid crystal display material.

To provide fine control of the alignment configurations and to produce an image on the display plate 122, the image retaining material 110 is disposed in a plurality of cells 124 that are formed in a cell wall structure 126. Each cell 124 makes up one pixel of an image and includes one or more spaced apart electrodes 112 that surrounds at least a portion of the image retaining material 110. The electrodes 112 may have any one of numerous configurations. In one exemplary embodiment, the cell wall structure 126 comprises glass or plates that are coated with indium tin oxide, or the like, to form transparent electrodes 112. The glass or plates may be coated with another coating that may affect the alignment configuration of the image retaining material 110 or the contrast or reflection of the cell 124.

The electrodes 112 are electrically coupled to the drive circuitry 114 and receive selected voltages therefrom to transform at least a portion of the image retaining material 110 to at least one of the focal conic, planar, and homeotropic alignment configurations. In one exemplary embodiment, the electrodes 112 of each cell 124 are configured to receive varying voltages so that the image retaining material 110 in each cell 124 may have a different alignment configuration. Preferably, the electrodes 112 are embedded into the cell wall structure 126; however, it will be appreciated that the electrodes 112 may be disposed in the cell wall structure 126 in any other suitable manner.

The electrical interface 116 is coupled to the drive circuitry 114 and is configured to provide an interface between the drive circuitry 114 and the cable 104. The electrical interface 116 may be any one of numerous suitable interfaces, such as, for example, a universal serial bus port. As shown in FIG. 1, the cable 104 is used to electrically couple the display 102 to the computer 106 and to provide power from the computer 106 to the drive circuitry 114. The computer 106 may be any type of computer, such as a personal digital assistant or a personal computer 106 and is preferably programmed to instruct the drive circuitry 114 to provide various voltages to the electrodes 112 to thereby display a desired image.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A tag for attachment to a garment, comprising:
a housing;
image retaining material disposed within the housing, the image retaining material capable of displaying a first static image in the absence of an electric field and transforming the first static image to a second static image in the presence of an electric field; and
a fastener coupled to the housing and configured to attach the housing to the garment.

2. The tag of claim 1, further comprising:
a display plate formed in the housing and disposed over the image retaining material.

3. The tag of claim 2, wherein the image retaining material is a bistable cholesteric liquid crystal display material.

4. The tag of claim 2, wherein the image retaining material is a chiral nematic liquid crystal display material.

5. The tag of claim 2, further comprising:
a cell wall structure that cooperates with the image retaining material to form at least one of a focal conic, planar, and homeotropic alignment configuration that is stable in the absence of an electric field.

6. The tag of claim 5, further comprising:
an electrode surrounding at least a portion of the image retaining material; and
drive circuitry electrically coupled to the electrode for applying selected voltages to the electrode for transforming at least a portion of the image retaining material to at least one of the focal conic, planar, and homeotropic alignment configurations.

7. The tag of claim 5, wherein the housing has an outer surface and the tag further comprises:
an electrical interface disposed on the outer surface and electrically coupled to the drive circuitry.

8. The tag of claim 1, wherein the fastener is a pin.

9. The tag of claim 1, wherein the fastener is a clip.

10. The tag of claim 1, wherein the fastener is configured to integrate the housing into a hat.

11. The tag of claim 1, wherein the fastener is configured to integrate the housing into an article of clothing.

12. A tag for attachment to a garment, comprising:
a wearable housing having an opening formed therein;
a display plate disposed over at least a portion of the opening;
a cell disposed within the housing;
image retaining material disposed within the cell and visible through the display plate, the image retaining material comprising a plurality of crystals capable of maintaining at least one of a focal conic, planar, and homeotropic alignment configuration that is stable in the absence of an electric field; and
a fastener coupled to the housing and configured to attach the housing to the garment.

13. The tag of claim 12, further comprising:
an electrode coupled to the cell and surrounding at least a portion of the image retaining material; and
drive circuitry electrically coupled to the electrode for applying selected voltages to the electrode for transforming at least a portion of the image retaining material to at least one of the focal conic, planar, and homeotropic alignment configurations.

14. The tag of claim 12, wherein the plurality of crystals is capable of transforming into another alignment configuration of the at least one of the focal conic, planar, and homeotropic alignment configurations in the presence of an electric field.

15. A wearable display system, comprising:
a wearable housing having an opening formed therein;
a display plate disposed over at least a portion of the housing opening;
a cell wall structure disposed in the housing, the cell wall structure including at least one cell;
image retaining material disposed within the cell and visible through the display plate, the image retaining material comprising a plurality of crystals capable of forming at least one of a focal conic, planar, and homeotropic alignment configuration in the absence of an electric field;
an electrode disposed within the cell and surrounding at least a portion of the image retaining material;
drive circuitry electrically coupled to the electrode for applying selected voltages thereto for transforming at least a portion of the image retaining material to at least one of the focal conic, planar, and homeotropic alignment configurations; and
an electrical interface coupled to the housing and electrically coupled to the drive circuitry.

16. The wearable display system of claim 14, further comprising:
a cable having a first end and a second end, the first end adapted to mate with the electrical interface.

17. The wearable display system of claim 15, further comprising:
a programmable computer adapted to mate with the cable second end.

18. The wearable display system of claim 16, wherein the programmable computer further comprises a computer program for providing instruction to the drive circuitry for applying the selected voltages to the electrodes for transforming the image retaining material into at least one of the focal, planar, and homeotropic alignment configurations.

19. The wearable display system of claim 14, wherein the image retaining material is a bistable cholesteric liquid crystal display material.

20. The wearable display system of claim 14, wherein the image retaining material is a chiral nematic liquid crystal display material.
